(19) United States
(12) Patent Application Publication
(10) Pub. No.: US 2012/0316965 A1
(43) Pub. Date: Dec. 13, 2012

(54) DYNAMIC TARGETED ADVERTISING IN CLIENT-SERVER TOPOLOGY

(75) Inventors: Robin Montague Mathews, Westford, MA (US); Michael P. Ruffini, Methuen, MA (US); Tushar Saxena, Lexington, MA (US)

(73) Assignee: VERIZON PATENT AND LICENSING INC., Basking Ridge, NJ (US)

(21) Appl. No.: 13/156,597

(22) Filed: Jun. 9, 2011

(51) Int. Cl. G06Q 30/00

(52) U.S. Cl. 705/14.61; 705/14.66

(57) ABSTRACT

A network device in a customer premises network collects profile data for a client device of multiple client devices in the customer premises network and sends the client profile data to a remote provider network. The network device receives, from the remote provider network, a group of advertisement files for targeted advertising to the client device and stores, in a memory, the group of advertisement files. The network device detects an advertisement insertion cue in linear program content being streamed to the client device, selects an advertisement file from the stored group of advertisement files, and inserts the selected advertisement file into the linear program content being streamed to the client device.

### BACKGROUND

Video content (e.g., television broadcasts, pay-per-view (PPV) content, video-on-demand (VOD) content, etc.) may be delivered to consumers and selected in several ways. For example, television channels may be broadcast to users. Traditionally, television broadcasts have been viewed on televisions sets, and, in many cases, using proprietary set-top boxes (STBs). More recently, users have been offered the ability to view television broadcasts on other devices, such as desktop computers, portable computers (e.g., tablet devices, laptops, etc.), and portable communication devices using standard viewing technology (e.g., commercial-off-the-shelf (COTS) applications).

Television broadcasts may include segments reserved for advertising, which is typically inserted by a service provider. It is preferred to target inserted advertising for the particular consumers viewing the television broadcasts.

### BRIEF DESCRIPTION OF THE DRAWINGS

FIG. 1 is a diagram that illustrates an exemplary network in which systems and/or methods, described herein, may be implemented;

FIG. 2 is a diagram of exemplary components of a device that may be used within the environment of FIG. 1;

FIG. 3 is a diagram of exemplary interactions between components of an exemplary portion of the network depicted in FIG. 1;

FIG. 4 is a diagram of exemplary functional components of the local media server of FIG. 1;

FIGS. 5 and 6 are flowcharts of an exemplary process for providing linear content with targeted advertising to a client device, according to an implementation described herein.

### DETAILED DESCRIPTION OF PREFERRED EMBODIMENTS

The following detailed description refers to the accompanying drawings. The same reference numbers in different drawings may identify the same or similar elements.

Systems and/or methods described herein may provide linear content with targeted advertising to a client device within a customer premises network that may include multiple client devices. In one implementation, a local server may send, to a remote provider network, client profile data associated with a client device in the customer premises network and may receive, from the remote provider network, a group of advertisement files for targeted advertising based on the client profile data. The local server may store the group of advertisement files locally. The local server may stream, to the client device, linear program content (e.g., selected by the user of the client device) and may detect an advertisement insertion cue in the linear program content. The local server may select an advertisement file from the stored group of advertisement files and may insert the selected advertisement file into the linear program content at a time-slot corresponding to the advertisement insertion cue.

Linear content may refer to content that is displayable in a predefined sequence, which is determined before a broadcast time of the content. An example of linear content may be a television program having advertisements inserted therein in a defined sequence before the program is broadcast. In another example, a television program may include multiple commercial timeslots (fifteen or thirty second timeslots) that sequentially follow one another.

Even within a single home, multiple consumers may view different television broadcasts at the same time. Presenting targeted advertising to multiple endpoints within a home during commercial breaks (e.g., in a live television stream) remains a challenge. The systems and/or methods described herein may provide a highly granular level of targeted advertising, down to individual client devices within a customer premises. Additionally, the systems and/or methods maintain a feedback control loop that allows for rapid and/or dynamic advertisement targeting. For example, assume a person watching a children's movie using a client device (e.g., a set-top box (STB)) in one room moves to another room and continues watching the same movie (e.g., on a different client device). The systems and/or methods described herein may send appropriate targeted advertisements quickly (e.g., to the client device in either room) based on stream information of the channel currently being watched.

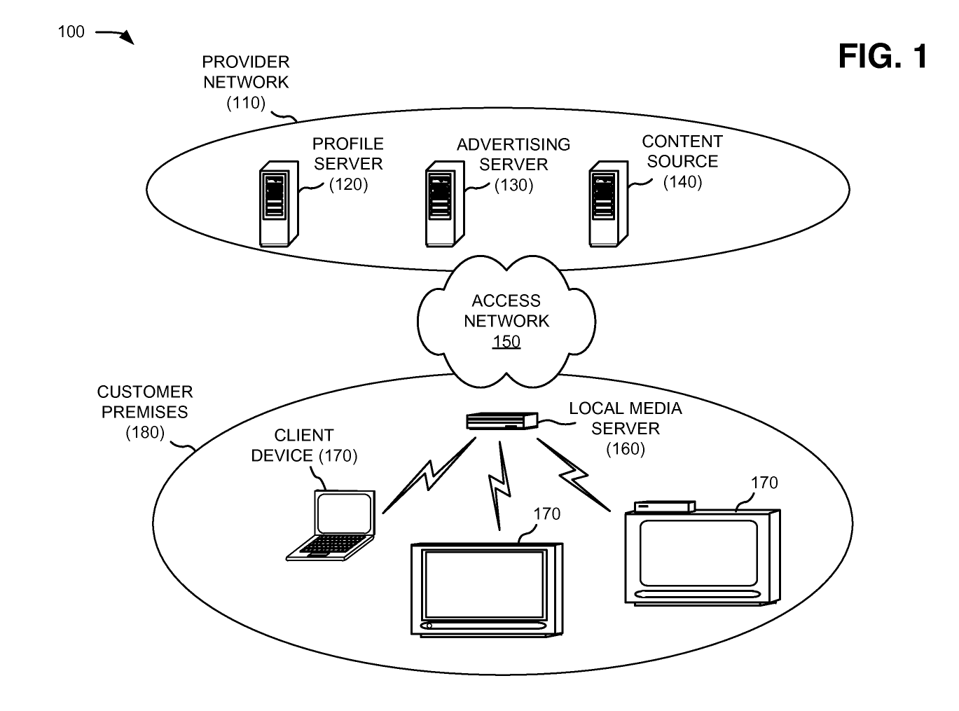

FIG. 1 is a diagram that illustrates an exemplary network 100 in which systems and/or methods described herein may be implemented. As shown in FIG. 1, network 100 may include a provider network 110, a profile server 120, an advertising server 130, a content source 140, an access network 150, a local media server 160, multiple client devices 170, and a customer premises network 180. Devices and/or networks of FIG. 1 may be connected via wired and/or wireless connections. These components are illustrated in FIG. 1 for simplicity. In practice, there may be more provider networks 110, profile servers 120, advertising servers 130, content sources 140, access networks 150, local media servers 160, client devices 170, and/or customer premises network 180. For example, there could be thousands of customer premises 180. Also, in some instances, a component of network 100 may perform one or more functions described as being performed by another component or group of components of network 100.

Provider network 110 may include a network that distributes or makes available services, such as, for example, television service, mobile service, and/or Internet service. Provider network 110 may be a satellite-based network and/or a terrestrial-based network. Provider network 110 may include, for example, customer information servers (e.g., profile server 120), advertising information servers (e.g., advertising server 130), content distribution devices (e.g., content source 140), content storage devices, application servers, billing devices, security devices, etc.

Profile server 120 may include one or more server devices, or other types of computation or communication devices, that gather, process, search, and/or provide information in a manner described herein. In one implementation, profile server 120 may receive a profile and match advertisements to the profile for targeted advertising. Profile server 120 may, for example, match characteristics of particular advertising (e.g., targeted demographics, product types, keywords, etc.) with characteristics of a particular profile (e.g., type of program content, type of channel, time of viewing, etc.). Based on a received profile, profile server 120 may generate a mapped listing of advertisement files (e.g., links, file names, descriptions, etc.) that match a particular profile and provide the mapped listing to local media server 160. Profile server 120 may communicate with local media server 160 to provide the mapped listing of advertisement files (e.g., links to particular advertising content) that may be associated (e.g., by local media server 160) with advertising breaks in a particular program stream.

In another implementation, profile server 120 may include user profile information for multiple users and/or groups of users and assign profiles to client devices 170 based on information received from local media server 160. The user profile information may include information to associate advertising with a particular type of content based on the projected audience. For example, profile server 120 may identify particular advertising available and/or suitable for viewers of a particular program stream (e.g., from content source 140).

The user profile information may include various information regarding a user, such as location information, types of services to which the user has subscribed, a list of video content purchased by the user, a list of video content rented by the user, a list of video content to which the user has subscribed, ratings of video content viewed by the user of client device 170, etc. Profile server 120 may use the profile information to associate client device 170 with one or more profiles. In one implementation, profile server 120 may assign a unique identifier to client device 170 that may correspond to the one or more profiles.

Advertising server 130 may include one or more server devices, or other types of computation or communication devices, that store advertising content that may be delivered to local media server 160. The advertising content may include, for example, advertising content and metadata that allows the advertising content to be associated with particular groups, categories, and/or profiles. In one implementation, advertising server 130 may provide advertising content to local media server 160 upon request from local media server 160. In another implementation, advertising server 130 may push down advertising content to local media server 160 based on profile information received from local media server 160.

Content source 140 may include one or more server devices that store and deliver content, such as video content, that may be delivered to local media server 160/client devices 170. The content may include, for example, television broadcasts, video-on-demand programming, or other video content. In one implementation, content source 140 may be included in a head-end unit (e.g., a super and/or local head-end unit), a base station, a central office, a video hub office (“VHO”), a video serving office (“VSO”), a network node, or a combination of one or more of these locations. The television programming may be stored and/or made available, by programming servers 140, in real-time or near real-time relative to the original broadcast of the television programming.

Access network 150 may generally include a local area network (LAN), a wide area network (WAN), a metropolitan area network (MAN), a wireless network, an optical fiber (or fiber optic)-based network, a cable television network, a satellite television network, or a combination of networks. Access network 150 may include an Internet Protocol (IP)-based network. In some implementations, access network 150 may be a private network controlled by, for example, a telecommunications company that provides television, telephone, and/or data access to customer premises network 180. In another implementation, access network 150 may be a public network, such as the Internet, or a combination of public and private networks.

Local media server 160 may include one or more network devices, or other types of computation or communication devices, that gather, process, search, and/or provide information in a manner described herein. In one implementation, local media server 160 may receive requests from client devices 170 and provide media content (e.g., from content source 140), responsive to the requests, to client devices 170. Local media server 160 may also collect profile data and define a profile type for a particular client device 170 based on the collected data. As described further herein, local media server 160 may also communicate with profile server 120, advertising server 130, and client devices 170 to provide targeted advertising, customized for each client device 170.

Client device 170 may include a STB, a television, a laptop computer, a tablet or “pad” computer, a personal computer, a game console, a personal communications system (PCS) terminal (e.g., that may combine a cellular radiotelephone with data processing and data communications capabilities), a PDA (e.g., that can include a radiotelephone, a pager, Internet/intranet access, etc.), a smartphone, or other types of computation and/or communication devices. In one implementation, client device 170 may include any device (e.g., an IP-based device) that enables a user to access the Internet and/or communicate with local media server 160. In an exemplary implementation, client device 170 may include a thin client application, such a proprietary multimedia player or a commercial-off-the-shelf (COTS) multimedia player, that plays streaming media content. The thin client application may be imbedded in other applications, such as a web browser or may be offered as a standalone device or application interface in a multi-purpose client device 170, such as a computer or a smartphone. Client device 170 may also be capable of sending tracked data (e.g., records of user input, features of devices, software versions, etc.) to local media server 160.

Customer premises network 180 may include local media server 160, client devices 170, and other equipment (such as routers, cables, splitters, etc., not shown) for a home network. Customer premises network 180 may connect to provider network 110 via access network 150.

Techniques described herein may be used to provide targeted advertising to individual client devices 170 within customer premises network 180 based on decisions by local media server 160. Local media server 160 may collect profile information for individual client devices 170 and/or users, may retrieve advertising segments appropriate for a particular profile, may store the advertising segments, and may selectively insert the advertising segments at advertising breaks of requested video content that is delivered to particular client devices 170. Local media server 160 may simultaneously provide requested video content combined with targeted advertising for different client devices 170 within customer premises network 180.

Each customer of provider network 110 may include a local media server 160. Local media server 160 may be located, for example, in the home of a residential customer or in the office space of a building of a business customer (co-located with client devices 170). As such, local media server 160 may be located remotely from provider network 110. Because local media server 160 may store advertisements locally, media server 160 may serve targeted advertisements with little delay between the content being displayed to the user and the advertisement being displayed to the user if advertisements were served from a remote location.

Although FIG. 1 shows exemplary components of network 100, in other implementations, network 100 may include fewer components, different components, differently arranged components, or additional components than depicted in FIG. 1.

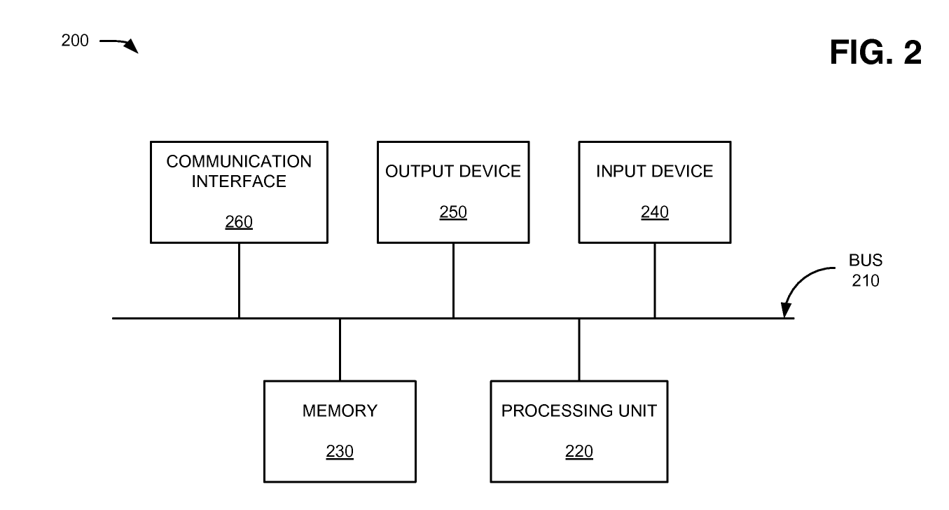

FIG. 2 is a diagram of exemplary components of a device 200. Device 200 may correspond to profile server 120, advertising server 130, content source 140, local media server 160, or client device 170. Each of profile server 120, advertising server 130, content source 140, local media server 160, or client device 170 may include one or more devices 200. As shown in FIG. 2, device 200 may include a bus 210, a processing unit 220, a memory 230, an input device 240, an output device 250, and a communication interface 260.

Bus 210 may permit communication among the components of device 200. Processing unit 220 may include one or more processors or microprocessors that interpret and execute instructions. In other implementations, processing unit 220 may be implemented as or include one or more application specific integrated circuits (ASICs), field programmable gate arrays (FPGAs), or the like.

Memory 230 may include a random access memory (RAM) or another type of dynamic storage device that stores information and instructions for execution by processing unit 220, a read only memory (ROM) or another type of static storage device that stores static information and instructions for the processing unit 220, and/or some other type of magnetic or optical recording medium and its corresponding drive for storing information and/or instructions.

Input device 240 may include a device that permits an operator to input information to device 200, such as a keyboard, a keypad, a mouse, a pen, a microphone, one or more biometric mechanisms, and the like. Output device 250 may include a device that outputs information to the operator, such as a display, a speaker, etc.

Communication interface 260 may include a transceiver (e.g., a transmitter and/or receiver) that enables device 200 to communicate with other devices and/or systems. For example, communication interface 260 may include mechanisms for communicating with other devices, such as other devices of network 100 or another device 200.

As described herein, device 200 may perform certain operations in response to processing unit 220 executing software instructions contained in a computer-readable medium, such as memory 230. A computer-readable medium may be defined as a non-transitory memory device. A memory device may include space within a single physical memory device or spread across multiple physical memory devices. The software instructions may be read into memory 230 from another computer-readable medium or from another device via communication interface 260. The software instructions contained in memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may include fewer components, different components, differently arranged components, or additional components than depicted in FIG. 2. As an example, in some implementations, input device 240 and/or output device 250 may not be implemented by device 200. In these situations, device 200 may be a “headless” device that does not explicitly include an input or an output device. Alternatively, or additionally, one or more components of device 200 may perform one or more other tasks described as being performed by one or more other components of device 200.

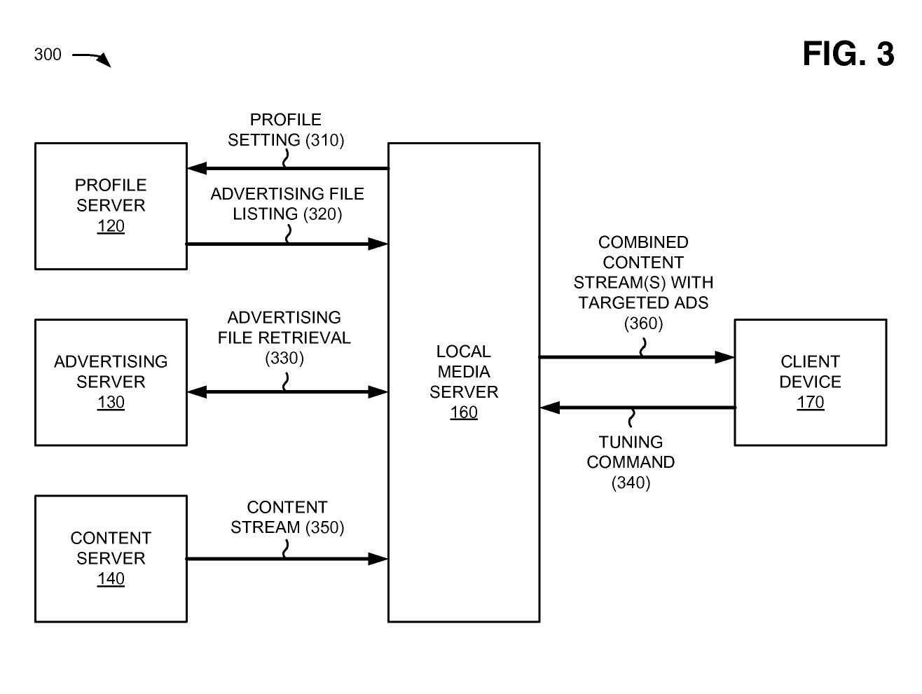

FIG. 3 depicts a diagram of exemplary interactions among components of an exemplary portion 300 of network 100. As illustrated, network portion 300 may include profile server 120, advertising server 130, content source 140, local media server 160, and client device 170. Profile server 120, advertising server 130, content source 140, local media server 160, and client device 170 may include the features described above in connection with one or more of FIGS. 1 and 2.

Local media server 160 may include profile settings for individual client devices 170 within customer premises network 180. Prior to an initial start-up, profile settings for each client device 170 may include a default profile (e.g., based on region, etc.). The default profile may be focused, for each client device 170, as profile information is collected from each respective client device 170. As further shown in FIG. 3, local media server 160 may provide a profile setting 310 for a particular client device 170 to profile server 120. Profile setting 310 may include, for example, a region (e.g., a default region) and may be updated with more specific targeting information. Targeting information may include, for example, a channel number recently/currently being viewed, a program currently/recently being viewed, viewing times, and/or advertising feedback.

Profile server 120 may receive profile setting 310 and may map the profile setting 310 to a mapped-listing of advertising assets. The mapped-listing of advertising assets may include, for example, uniform resource locators (URLs) to access particular advertising files (e.g., from advertising server 130) that correspond to a particular profile. Profile server 120 may provide the mapped-listing of advertising assets to local media server 160 as advertising file listing 320. For example, depending upon the type of profile information received from local media server 160, advertising file listing 320 may include advertising for a particular demographic (e.g., six-year-old boy; middle-aged mother, etc.) and interests particular to viewing events associated with a particular client device 170.

Local media server 160 may receive advertising file listing 320 and, using the URLs provided, may retrieve advertising files from advertising server 130, as indicated by reference number 330. Local media server 160 may store the advertising files in a local memory (e.g., memory 230) associated with a particular client device 170. In one implementation, local media server 160 may retrieve advertising files from advertising server 130 as a background process while linear content is provided to local media server 160.

Based on a tuning command 340 from client device 170 (e.g., initiated by a user of client device 170), local media server 160 may tune to content stream 350 from content server 140. Local media server 160 may detect places in the media stream 350 that require advertising (e.g., advertising breaks), and insert into content stream 350 one or more targeted advertisement from stored advertising files 330 for client device 170. Local media server 160 may send the combined content stream with the target advertisement (e.g., from stored advertising files 330) to client device 170, as indicated by reference number 360.

In one implementation, since the advertisement files are stored locally (e.g., within customer premises network 180), then local media server 160 may continue to download content stream 350 in the background. This may allow local media server 160 to buffer additional content, which may provide a better user experience (e.g., higher quality video/audio, lower likelihood of frozen video/audio, etc.)

Although FIG. 3 shows exemplary components of network portion 300, in other implementations, network portion 300 may include fewer components, different components, differently arranged components, and/or additional components than depicted in FIG. 3. Alternatively, or additionally, one or more components of network portion 300 may perform one or more other tasks described as being performed by one or more other components of network portion 300.

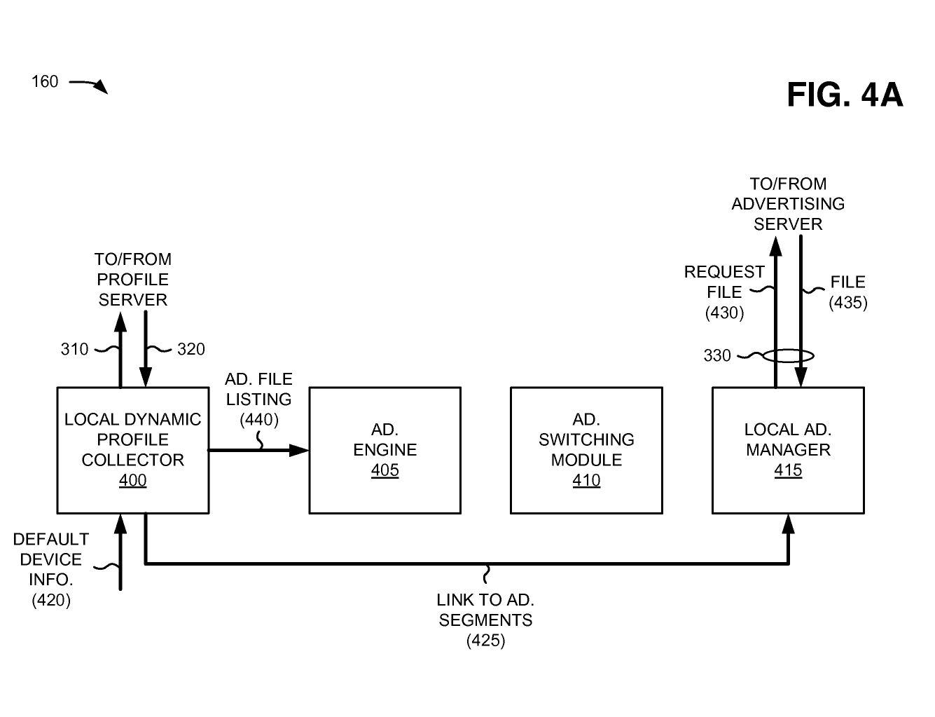

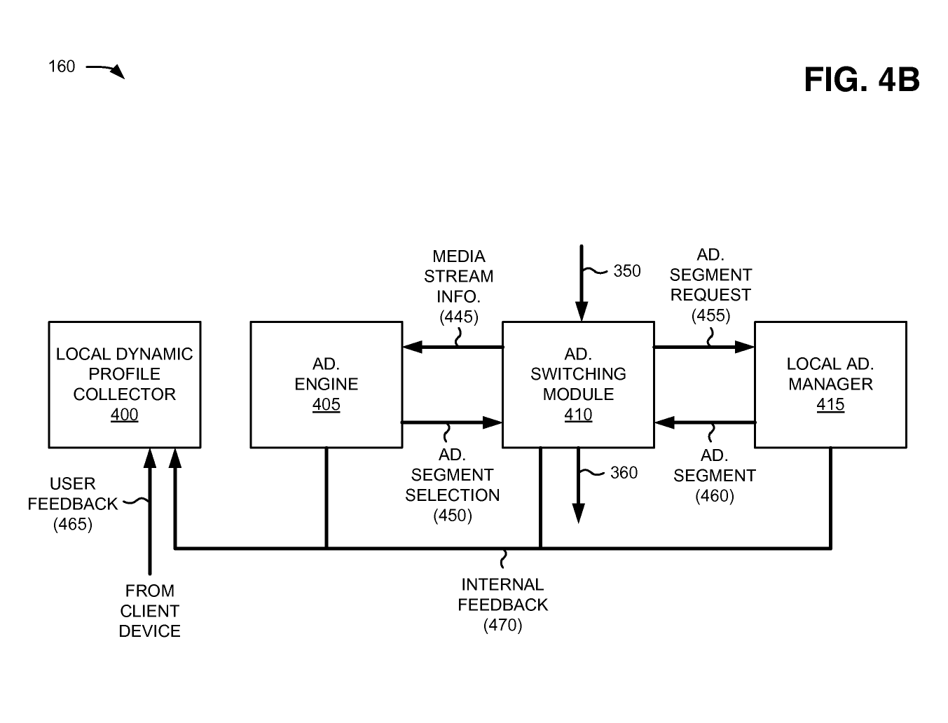

FIGS. 4A and 4B are diagrams of exemplary functional components of local media server 160. In one implementation, the functions described in connection with FIGS. 4A and 4B may be performed by one or more components of device 200 (FIG. 2). As shown in FIGS. 4A and 4B, local media server 160 may include a local dynamic profile collector 400, an advertisement engine 405, an advertisement switching module 410, and a local advertisement manager 415.

Referring to FIG. 4A, local dynamic profile collector 400 may receive a default profile 420 for a client device 170. Default profile 420 may be provided, for example, as part of an initial configuration of client device 170. Default profile 420 may include geographic information (e.g., region, zip code, etc.), service level information (e.g., basic, premium, etc.), and/or other information relevant particularly to client device 170 or to customer premises network 180. In one implementation, default profile 420 may be provided by a user of client device 170 (e.g., as part of an initial settings process). In another implementation, default device information 420 may be configured by a service technician.

Local dynamic profile collector 400 may store default device information 420 and may forward default device information 420 to profile server 120 as profile setting 310. In one implementation, local dynamic profile collector 400 may provide profile setting 310 on a periodic basis. In another implementation, local dynamic profile collector 400 may provide profile setting 310 whenever a change to default device information 420 is received. In still another implementation, local dynamic profile collector 400 may respond to a request (not shown) from profile server to provide profile setting 310.

Based on profile setting 310, local dynamic profile collector 400 may receive advertising file listing 320 from profile server 120. Advertising file listing 320 may include, for example, a single link (or URL) for a group of advertisements relevant to the profile in profile setting 310. In another example, advertising file listing 320 may include a list of separate links (or URLs) for individual advertising segments. Local dynamic profile collector 400 may provide the links to advertising segments (from advertising file listing 320) to local advertisement manager 415, as indicated by reference number 425.

Local advertisement manager 415 may receive links to advertising segments 425 and, in response, send a request for files 430 to advertising serve 130 to obtain advertising segments corresponding to the adverting file listing 320. Local advertisement manager 415 may receive the requested files 435 and store the files for future use. In one implementation, local advertisement manager 415 may also manage memory capacity/resources for files 435. For example, local advertisement manager 415 may overwrite locally-stored advertisement files that are not included in the most recent links to advertising segments 425. In another implementation, local advertisement manager 415 may store advertising segments for a period of time (e.g., 24 hours) and designate them as not current if, for example, they are not part of the current links to advertising segments 425. Thus, local advertisement manager 415 may store advertising files that are not designated for presentation to a user (e.g., not current) and may simply change the status of a locally-stored advertising segment (e.g., from not current to current) if links to advertising segments 425 includes a previously used advertisement.

Local dynamic profile collector 400 may also provide the links to advertising segments (from advertising file listing 320) to advertisement engine 405, as indicated by reference number 440. Advertisement file listing 440 may include all or a portion of the information included in advertising file listing 320.

Referring to FIG. 4B, advertisement switching module 410 may tune to content stream 350 (e.g., based on a signal from client device 170). Content stream 350 may include locations (or time-slots) within content stream 350 that are reserved for advertising. These locations may be indicted by markers (or “cue tones”) within content stream 350 to indicate a place and duration of an advertising break. Content stream 350 may include a default advertisement for a time-slot that may be overwritten with a local advertisement. In one implementation, advertisement switching module 410 may detect an advertising break in content stream 350 and, in response, may provide media stream information 345 to advertisement engine 405. Media stream information 345 may identify, for example, the particular client device 170 (e.g., in customer premises network 180) that is receiving content stream 350 and/or a type of program content (e.g., a genre, rating, etc.).

Advertisement engine 405 may use advertisement file listing 440 (e.g., previously received from local dynamic profile collector 400) and media stream information 445 to select an appropriate advertisement to insert into the advertising break of content stream 350. For example, advertisement engine 405 may associate media stream information 445 with a particular profile (e.g., associated with client device 170) and may select an advertisement from the current list of advertisements associated with the particular profile. In one implementation, advertising engine 405 may select an advertising file based on a round-robin selection process. In another implementation, advertisement engine 405 may include other factors in an advertisement selection process, such as time of day, current program content (e.g., in content stream 350), length of advertisement, length of timeslot, etc. Advertisement engine 405 may provide an indication of the selected advertisement segment 450 to advertisement switching module 410. Advertisement segment selection 450 may include, for example, a file name, a portion of a URL, or another indicator that may be associated with an identifier for the current content stream 350.

Advertisement switching module 410 may receive advertisement segment selection 450 and, in response, may request the selected advertisement segment from local advertisement manager 415, as indicated by reference number 455. Local advertisement manager 415 may retrieve the file indicated in advertisement segment request 455 and may provide advertisement segment 460 to advertisement switching module 410. Advertisement switching module 410 may insert advertisement segment 460 into the advertising break of content stream 350 and may forward content steam 350 with advertisement segment 460 to client device 170, as indicated by reference number 360. If no advertisement segment selection 450 or advertisement segment 460 is available, advertisement switching module 410 may fall back to an advertisement of last resort (e.g., a stored regional advertisement, a default advertisement included in content stream 350, etc.)

Local media server 160 may implement a feedback loop to dynamically update profile information from each client device 170. For example, local dynamic profile collector 400 may receive user feedback 465 from client device 170. User feedback 465 may include, for example, user interactions (e.g., via a remote control) that may correspond to a particular advertisement, such as changing a channel during the advertisement, muting the audio, activating other menu options, pausing/rewinding the content stream, etc.

Local dynamic profile collector 400 may also collect internal feedback 470 from one or more of advertisement engine 405, advertisement switching module 410, and/or local advertisement manager 415. Internal feedback 470 may include, for example, whether advertisement segment 460 was successfully spliced into content stream 350, whether a local advertising segment was available (e.g., in local advertisement manager 415) that matches a profile for client device 170. Internal feedback 470 may also include updated targeting information, such as channels/time viewed with a particular client device, number of client devices matching each targeting criteria, etc.). Local dynamic profile collector 400 may receive user feedback 465 and internal feedback 470 and process feedback 465/470 to generate an updated profile setting. The updated profile setting may be forwarded to profile server 120 (e.g., as profile settings 310) to dynamically adjust targeted advertising for client devices 170.

While communications/functions of local media server 160 have been described with respect to a single client device 170 and content stream 350. In practice, local media server 160 may simultaneously perform advertisement insertion functions for multiple client devices viewing different content streams 350.

Although FIGS. 4A and 4B show exemplary functional components of local media server 160, in other implementations, local media server 160 may include fewer, different, differently-arranged, and/or additional functional components than depicted in FIGS. 4A and 4B. Alternatively, or additionally, one or more components of local media server 160 may perform one or more other tasks described as being performed by one or more other components of local media server 160. In addition, while the functional components may be described as “local” some functions described herein may be performed remotely (e.g., by a server provider network 110).

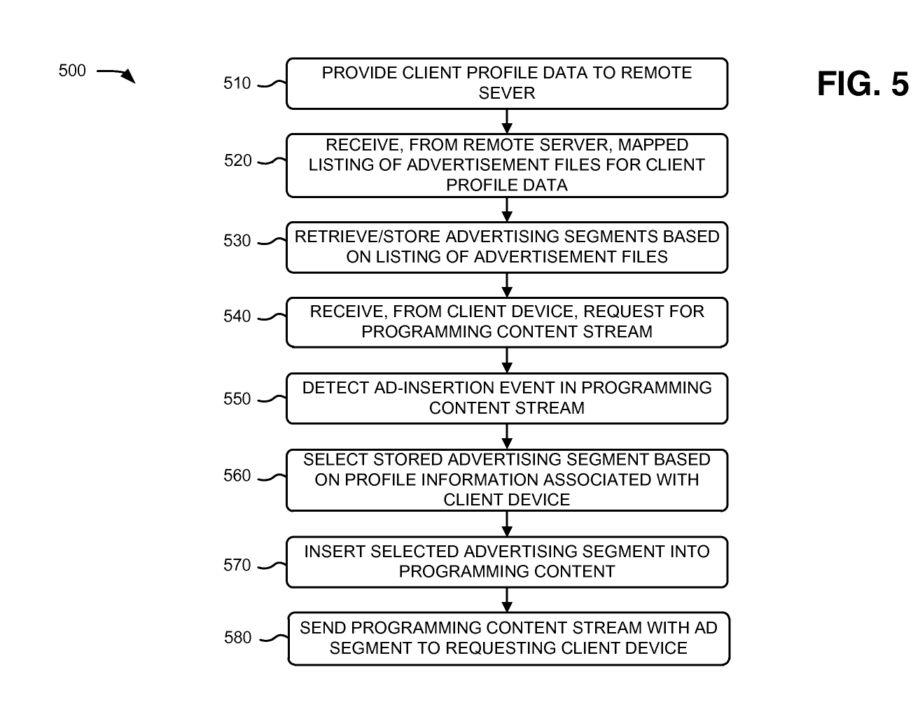

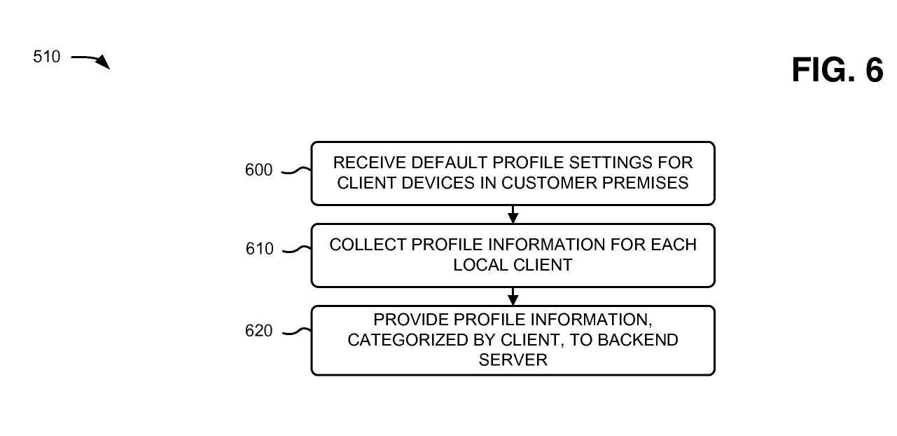

FIGS. 5 and 6 are flowcharts of an exemplary process 500 for providing targeted advertising to a client device, according to an implementation described herein. In one implementation, process 500 may be performed by one or more components of local media server 160, such as one or more processing units 220. In another implementation, one or more blocks of process 500 may be performed by one or more other devices or a group of devices including or excluding local media server 160.

Process 500 may include providing client profile data to a remote server (block 510) and receiving, from the remote server, a mapped-listing of advertisement files for the client profile (block 520). For example, as described in connection with FIG. 3, local media server 160 may provide a profile setting 310 for a particular client device 170 to profile server 120. Profile setting 310 may include, for example, a default profile (e.g., based on region) that may eventually be updated with targeting information for a particular client device, such as channels viewed, viewing times, and/or advertising feedback/interactions. Profile server 120 may receive profile setting 310 and may map the profile setting 310 to a mapped-listing of advertising assets. The mapped-listing of advertising assets may include, for example, uniform resource locators (URLs) to access particular advertising files (e.g., from advertising server 130) that correspond to a particular profile. Profile server 120 may provide the mapped-listing of advertising assets, which may be received by local media server 160 as advertising file listing 320.

Process 500 may also include retrieving and/or storing advertising files based on the listing of advertisement files (block 530). For example, as described in connection with FIG. 3, local media server 160 may receive advertising file listing 320 and, using URLs or other links provided in advertising file listing 320, may retrieve advertising files from advertising server 130, as indicated by reference number 330. Local media server 160 may store the advertising files in a local memory (e.g., memory 230) associated with a particular client device 170.

Process 500 may also include receiving, from a client device, a request for a programming content stream (block 540), and detecting an advertisement insertion event in the requested programming content stream (block 550). For example, as described above in connection with FIG. 3, local media server 160 may receive a tuning command 340 from client device 170 (e.g., initiated by a user of client device 170), and tune to content stream 350 from content server 140. Local media server 160 may detect places in content stream 350 that require advertising (e.g., advertising breaks). These locations may be indicted by markers (or “cue tones”) within content stream 350 to indicate a place and duration of an advertising break.

Referring again to FIG. 5, process 500 may include selecting a stored (e.g., locally) advertising segment based on profile information associated with the client device (block 560). For example, as described above in connection with FIGS. 3 and 4B, local media server 160 (e.g., advertisement engine 405) may use advertisement file listing 440 (e.g., previously received from local dynamic profile collector 400) and media stream information 445 to select an appropriate advertisement to insert into the advertising break of content stream 350. For example, advertisement engine 405 may associate media stream information 445 with a particular profile (e.g., associated with client device 170) and may select an advertisement from the current list of advertisements associated with the particular profile. In one implementation, advertising engine 405 may select an advertising file (from the current list of advertisements associated with a profile) based on a round-robin selection process. In another implementation, advertisement engine 405 may include other factors in an advertisement selection process, such as time of day, current program content (e.g., in content stream 350), etc. Advertisement engine 405 may provide an indication of the selected advertisement segment 450 to advertisement switching module 410. Advertisement segment selection 450 may include, for example, a file name, a portion of a URL, or another indicator that may be associated with an identifier for the current content stream 350.

Process 500 may include inserting the locally-stored advertising segment into the programming content stream (block 570), and sending the requested programming content stream to the client device (block 580). For example, as described above in connection with FIGS. 3 and 4B, local media server 160 (e.g., advertisement switching module 410) may insert into content stream 350 one or more targeted advertisement from stored advertising files 330 for client device 170. Local media server 160 may send the combined content stream with the target advertisement (e.g., from stored advertising files 330) to client device 170, as indicated by reference number 360.

Process block 510 may include the process blocks depicted in FIG. 6. As shown in FIG. 6, process block 510 may include receiving default profile settings for client devices in customer premises (block 600), collecting profile information for each local client device (block 610), and providing profile information, categorized by client device, to a backend server (block 620). For example, as described above in connection with FIGS. 4A-4B, local media server 160 (e.g., local dynamic profile collector 400) may store default device information 420 and may forward default device information 420 to profile server 120 as profile setting 310. In one implementation, local dynamic profile collector 400 may provide profile setting 310 on a periodic basis. In another implementation, local dynamic profile collector 400 may provide profile setting 310 whenever a change to default device information 420 is received. Local media server 160 may implement a feedback loop to dynamically update profile information from each client device 170. For example, local dynamic profile collector 400 may receive user feedback 465 (e.g., indications of whether a user actually watched the advertisement) from client device 170. Local dynamic profile collector 400 may also collect internal feedback 470 from one or more of advertisement engine 405, advertisement switching module 410, and/or local advertisement manager 415. Local dynamic profile collector 400 may receive user feedback 465 and internal feedback 470 and process feedback 465/470 to generate an updated profile setting. The updated profile setting may be forwarded to profile server 120 (e.g., as profile settings 310) to dynamically adjust targeted advertising for client devices 170.

Systems and/or methods described herein may provide different targeted advertising to multiple client devices within a customer premises network. The systems and/or methods may collect profile data for a client device of multiple client devices in the customer premises network and may send the client profile data to a remote provider network. The systems and/or methods may receive, from the remote provider network, a group of advertisement files for targeted advertising to the client device and may store, in a memory, the group of advertisement files. The systems and/or methods may detect an advertisement insertion cue in linear program content being streamed to the client device, may select an advertisement file from the stored group of advertisement files, and may insert the selected advertisement file into the linear program content being streamed to the client device.

The foregoing description provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 5 and 6, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the invention may be implemented as a “component” that performs one or more functions. These components may include hardware, such as a processor, an ASIC, or a FPGA, or a combination of hardware and software.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A method performed by a local network device in a customer premises network, comprising:
sending, by the local network device in the customer premises network and to a remote provider network, client profile data associated with a client device in the customer premises network;
receiving, by the local network device and from the remote provider network, a group of advertisement files for targeted advertising based on the client profile data;
storing, by the local network device, the group of advertisement files;
receiving, by the local network device and from the client device, a selection of linear program content;
detecting, by the local network device, an advertisement insertion cue in the linear program content;
selecting, by the local network device and based on the advertisement insertion cue, an advertisement file from the stored group of advertisement files;
inserting, by the local network device, the selected advertisement file into the linear program content at a time-slot corresponding to the advertisement insertion cue; and
sending, by the local network device, the liner program content with the selected advertisement file to the client device.

2. The method of claim 1, wherein selecting the advertisement file from the stored group of advertisement files includes:
performing a round-robin selection process from the stored group of advertisement files, or
selecting an advertisement based on one or more of a time of day or a type of content in the linear program content.

3. The method of claim 1, wherein the profile data includes channels viewed on the client device, programs viewed on the client device, viewing times for the client device, or user feedback to advertisements presented on the client device.

4. The method of claim 1, further comprising:
receiving, by the local server and from the remote provider network, a mapped listing for the group of advertisement files; and
requesting, by the local server and from the remote provider network, the group of advertisement files based on the mapped listing for the group of advertisement files.

5. The method of claim 1, wherein sending client profile data associated with the client device in the customer premises network, further includes sending client profile data associated with multiple client devices in the customer premises network, and
wherein receiving the group of advertisement files for targeted advertising based on the client profile data further includes receiving listings for different groups of advertisement files associated with different of the multiple client devices.

6. The method of claim 1, further comprising:
collecting, from one of the client device or the local server, updated profile data for the client device;
sending, to the remote provider network, the updated profile data;
receiving, from the remote provider network, an updated group of advertisement files for targeted advertising based on the updated client profile data;
storing, in a local memory, the updated group of advertisement files;
detecting another advertisement insertion cue in the linear program content;
selecting, based on the other advertisement insertion cue, another advertisement file from the stored updated group of advertisement files;
inserting the selected other advertisement file into the linear program content at a time-slot corresponding to the other advertisement insertion cue; and
sending, by the local server, the liner program content with the other selected advertisement file to the client device.

7. The method of claim 1, wherein storing the updated group of advertisement files further comprises:
overwriting, with the updated group of advertisement files, the group of advertisement files, or
marking as not current particular stored advertising files that are not included in the updated group of advertisement files.

8. The method of claim 1, further comprising
associating a group of advertisement files with a particular profile, and
generating a mapped listing for the group of advertisement files.

9. A network device, comprising:
a memory to store a plurality of instructions; and
a processor configured to execute instructions in the memory to:
collect profile data for a client device of multiple client devices in a customer premises network,
send, to a remote provider network, the client profile data,
receive, from the remote provider network and based on the client profile data, a group of advertisement files for targeted advertising to the client device,
store, in the memory, the group of advertisement files,
detect an advertisement insertion cue in linear program content being streamed to the client device,
select, based on the advertisement insertion cue, an advertisement file from the stored group of advertisement files, and
insert the selected advertisement file into the linear program content being streamed to the client device.

10. The network device of claim 9, wherein the processor is further configured to:
receive, from the client device, a selection of linear program content;
send the liner program content with the selected advertisement file to the client device.

11. The network device of claim 9, wherein, when selecting an advertisement file from the stored group of advertisement files, the processor is further configured to:
select the advertisement, from the stored group of advertisements, based on one or more of a time of day or a type of content in the linear program content.

12. The network device of claim 9, wherein, when selecting an advertisement file from the stored group of advertisement files, the processor is further configured to:
select the advertisement, from the stored group of advertisements, based on a round-robin selection process.

13. The network device of claim 9, wherein the profile data includes channels viewed on the client device, programs viewed on the client device, viewing times for the client device, or user feedback to advertisements presented on the client device.

14. The network device of claim 9, wherein the processor is further configured to:
receive, from the remote provider network, a mapped listing for the group of advertisement files; and
request, from the remote provider network, the group of advertisement files based on the mapped listing for the group of advertisement files.

15. The network device of claim 9, wherein the processor is further configured to:
detect a different advertisement insertion cue the linear program content being streamed to the client device,
select, based on the different advertisement insertion cue, another advertisement file from the stored group of advertisement files, and
insert the selected advertisement file into the linear program content being streamed to the client device.

16. The network device of claim 9, wherein the processor is further configured to:
send the liner program content with the selected advertisement file to the client device,
collect updated profile data for the client device,
send, to the remote provider network, the updated profile data,
receive, from the remote provider network, an updated group of advertisement files based on the updated client profile data, and
store, in the local memory, the updated group of advertisement files.

17. A network, comprising:
a profile server configured to associate a profile with a group of advertising files;
an advertising server configured to provide advertising files to customer devices;
a local server for a group of client devices in a customer premises network, wherein the local server is configured to:
determine a profile for each client device of the group of client devices,
send, to the profile server, the collected profile for each client device,
receive, from the profile server and based on one of the collected profiles, a mapped listing of advertisement files for each client device of the group of client devices,
request, from the advertising server and based on the mapped listing of advertisement files, the advertisement files,
receiving, from the advertising server, the advertisement files;
detect an advertisement insertion cue in linear program content being streamed to one of the client devices of the group of client devices,
select, based on the advertisement insertion cue and the mapped listing of the advertisement files for the one of the client devices of the group of client devices, an advertisement file from the stored group of advertisement files, and
insert the selected advertisement file into the linear program content being streamed to the one of the client devices of the group of client devices.

18. The network of claim 17, wherein the profile server is further configured to:
generate, based on the collected profile for each client device, different mapped listings of advertisement files for each client device of the group of client devices.

19. The network of claim 18, wherein the different mapped listings of advertisement files include uniform resource locators (URLs) to access particular advertising files from the advertising server.

20. The network of claim 17, wherein the one of the client devices of the group of client devices includes a:
a set-top box
a television,
a laptop computer,
a tablet computer,
a personal computer,
a game console,
a personal communications system (PCS) terminal,
a personal digital assistant (PDA), or
a smartphone.
